(19) United States
(12) Patent Application Publication
(10) Pub. No.: US 2001/0045894 A1
(43) Pub. Date: Nov. 29, 2001

(54) Locator apparatus system

(76) Inventors: Richard Slavin, Oceanside, NY (US); Stella Slavin, Oceanside, NY (US)

Correspondence Address: Mathew J. Peirce, Esq., 1550 Starlight Canyon Avenue, Las Vegas, NV, 89123, US

(21) Appl. No.: 09/775,702

(22) Filed: Feb. 3, 2001

Related U.S. Application Data
(60) Provisional application No. 60/180,179, filed on Feb. 4, 2000.

(51) Int. Cl. G08B 23/00

(52) U.S. Cl. 340/573.4

(57) ABSTRACT

A locator apparatus is disclosed for assisting a parent, guardian, or other caregiver the ability to locate a child or other individual. To activate the locator apparatus, a transmitter would be activated which would emit radio waves of a specific wavelength. A radio wave receiver on the locator apparatus would pick up the radio waves emitted from the transmitter, causing a homing device on the locator apparatus to emit radio waves of a second specific wavelength. The radio waves of the second specific wavelength would be picked up a radio wave receiving and notification system which would be capable of pinpointing the location of the particular homing device (and the individual) being sought.

### I. BACKGROUND OF THE INVENTION

The present invention concerns that of a new and improved apparatus for assisting a parent, guardian, or other caregiver the ability to locate a child or other person being cared for.

### II. DESCRIPTION OF THE PRIOR ART

U.S. Pat. No. 5,617,074, issued to White, discloses a transmitter which is concealingly attached to a child's body and sends a signal to a conventional receiver so that the child's location can be continually monitored.

U.S. Pat. No. 5,014,040, issued to Weaver et al., discloses a personal locator transmitter adapted to be worn on the wrist and having the size and appearance of a conventional wrist-watch.

### III. SUMMARY OF THE INVENTION

A locator apparatus system is disclosed for assisting a parent, guardian, or other caregiver the ability to locate a child or other individual. To activate the locator apparatus system, a transmitter would be activated which would emit radio waves of a specific wavelength. A radio wave receiver on the locator apparatus system would pick up the radio waves emitted from the transmitter, causing a homing device on the locator apparatus to emit radio waves of a second specific wavelength. The radio waves of the second specific wavelength would be picked up a radio wave receiving and notification system which would be capable of pinpointing the location of the particular homing device (and the individual) being sought. In addition, the homing device would activate a light on the locator apparatus system, further indicating to the missing person and other surrounding people that other people are looking for this particular person. The locator apparatus system would preferably be located on a watch, but could alternatively be placed on a pendant, bracelet, or any other form of jewelry or clothing that is typically attached to a person's body. The present invention could be used to not only properly keep track of children, but could also keep track of elderly people, especially those with dementia, Alzheimer's disease, or other chronic conditions in which constant care and attention are always needed. In addition, the present invention could also be used with a pet, in order to ensure that if a pet would become lost, an owner or other person could quickly locate the pet.

There has thus been outlined, rather broadly, the more important features of a locator apparatus system in order that the detailed description thereof that follows may be better understood and in order that the present contribution to the art may be better appreciated. There are, of course, additional features of the locator apparatus system that will be described hereinafter and which will form the subject matter of the claims appended hereto.

In this respect, before explaining at least one embodiment of the locator apparatus system in detail, it is to be understood that the locator apparatus system is not limited in its application to the details of construction and to the arrangements of the components set forth in the following description or illustrated in the drawings. The locator apparatus system is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present locator apparatus system. It is important, therefore, that the claims be regard as including such equivalent constructions insofar as they do not depart from the spirit and scope of the present invention.

It is therefore an object of the present invention to provide a locator apparatus system which has all of the advantages of the prior art and none of the disadvantages.

It is another object of the present invention to provide a locator apparatus system which may be easily and efficiently manufactured and marketed It is another object of the present invention to provide a locator apparatus system which is of durable and reliable construction.

It is yet another object of the present invention to provide a locator apparatus system which is economically affordable and available to the buying public.

It is yet another object of the present invention to provide a locator apparatus system which provides additional benefits not present in the prior art.

It is yet another object of the present invention to provide a locator apparatus system which is, in part, compact and not readily visible.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 is a front view of the present invention as it would appear associated with a watch.

FIG. 2 is a view of a child wearing the present invention as it would be associated with a watch.

FIG. 3 shows the present invention in use by a small child.

### V. DESCRIPTION OF THE PREFERRED EMBODIMENT

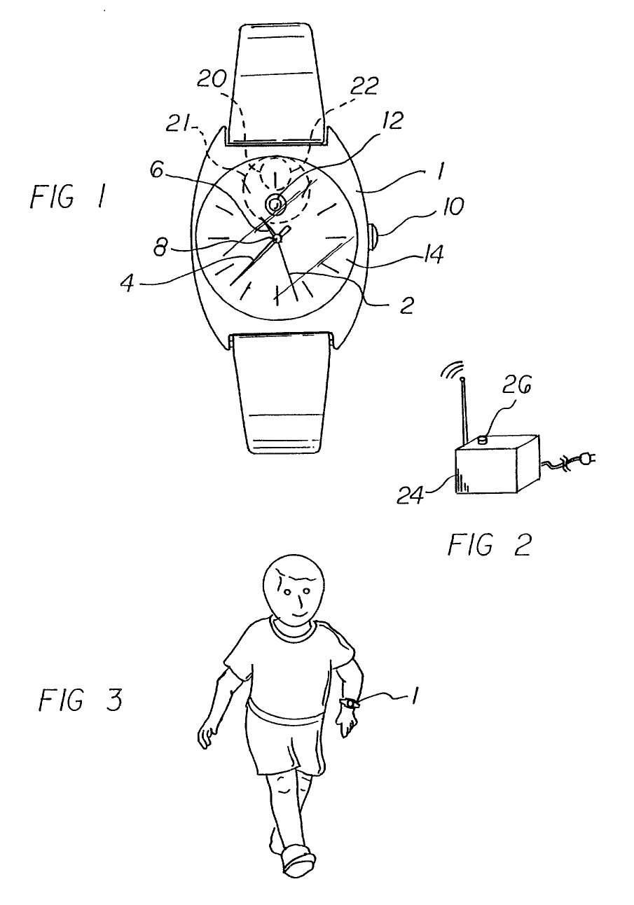

FIG. 1 is a front view of the present invention as it would appear associated with a watch. The present invention is shown with watch 1, which includes second hand 2, minute hand 4, and hour hand 6. All three hands are rotatably mounted to point 8, around which they freely rotate. Second hand 2, minute hand 4, hour hand 6, and point 8 are protected by glass 14, which is a covering layer standard with almost all watches.

Watch 1 also includes knob 10, which is used to regularly wind the watch and reset the hour and minute hands, if a user so desires. Watch 1 can be attached to a user's wrist or other body extension by band 16, which is a cylindrical band attached to both the upper edges and lower edges of the front face of watch 1.

The internal mechanisms of the locator apparatus within watch 1 also include at least one computer chip 20 and a homing device 22. The computer chip 20, along with incorporated receiver 21, is designed to pick up a transmitted signal from a transmitter 24 that would be kept by a parent, guardian, or caregiver. Upon receipt of a radio wave of the correct wavelength, computer chip 20, along with receiver 21, will activated homing device 22. Homing device 22 will send a return signal, indicating the present location of the missing person or pet. A power source would provide power to computer chip 20, receiver 21, and homing device 22.

Depending on the type of technology used with the return signal, the signal may have varying degrees of accuracy when designating the location of the missing person or pet. Preferably, the invention could use the Global Positioning System (GPS) technology that is currently in use, but the present invention could also use various other technologies currently in use.

The return signal from the homing device 22 would be picked up by notification system or receiver which would be capable of relaying information as to the particular location of homing device 22. With this information, the location of homing device 22 (and the individual it would be attached to) would be quickly pinpointed and thus, the person wearing homing device 22 quickly located In addition to sending a return signal, homing device 22 and computer chip 20 would activate light 12. Light 12 would be located on the face of watch 1 and would blink at regular intervals once a transmitted signal would be received The blinking of light 12 would indicate to the wearer that he or she should return to their residence. If the person wearing the present invention is an older person who may have wandered away, the present invention may alert other nearby people that the older person may be lost or needed assistance.

The present invention would not be limited to use with watches. The present invention could also be used with many other types of jewelry, such as a necklace, bracelet, pendant, or any other type of jewelry or object commonly attached to a person or pet. Furthermore, the present invention could be incorporated into specific items of clothing

FIG. 2 shows a representative picture of what a transmitter 24 could look like. Transmitter 24 would likely include a button 26 and a power source. Button 26 would be pushed in order to send a signal that would be of the appropriate wavelength for receiver 21 to recognize. The power source of the present invention would preferably be from direct current from a battery source, but could alternatively use alternating current from a standard electrical wall outlet.

FIG. 3 shows the present invention in use by a small child. As can be seen, the present invention is not noticeable and would greatly assist a parent, guardian, or caregiver in locating the child should the child get lost or kidnapped.

What I claim as my invention is:

1. A locator apparatus comprising
(a) a radio wave receiver designed to receive and recognize a radio signal of a first specific wavelength,
(b) a homing device designed to emit a radio signal of a second specific wavelength after the radio wave receiver has received and recognized a radio signal whose wavelength is equal to that of the first specific wavelength,
(c) computational means for determining whether the radio wave receiver has received signals that correspond to the first specific wavelength that the radio wave receiver would be designed to receive, the computational means being connected to both the radio wave receiver and the homing device, the computational means also designed to activate the homing device to emit a radio signal of a second specific wavelength after the radio wave receiver has received and recognized a radio signal whose wavelength is equal to that of the first specific wavelength,
(d) power means for providing power to the computational means, the power source also providing power to the radio wave receiver, and the power source further providing power to the homing device,
(e) a light, the light being powered by the power means, the light being connected to the computational means, the light being programmed to blink on and off when the computational means activates the homing device to emit a radio signal of a second specific wavelength, and
(f) attachment means for attaching the locator apparatus to an individual.

2. A locator apparatus according to claim 1 in combination with a transmitter, the transmitter being distantly located from the locator apparatus, the transmitter capable of emitting a radio wave signal equal in wavelength to that of the first specific wavelength, the transmitter capable of emitting a radio wave signal equal in wavelength to that of the first specific wavelength with enough amplitude to allow the radio wave receiver on the locator apparatus to receive the emission.

3. A locator apparatus according to claim 2 in combination with a radio wave receiving and notification system, the radio wave receiving and notification system being distantly located from the locator apparatus, the radio wave receiving and notification system capable of recognizing and receiving a wavelength equal to that the second specific wavelength emitted by the homing device, the radio wave receiving and notification system designed to determine the location of a particular homing device, the radio wave receiving and notification system further designed to notify individuals of the physical location of a particular homing device.

4. A locator apparatus according to claim 3 wherein the radio wave receiving and notification system utilizes a global positioning system.

5. A locator apparatus according to claim 1 wherein the locator apparatus is incorporated into a watch.

6. A locator apparatus according to claim 1 wherein the locator apparatus is incorporated into a piece of jewelry.

7. A locator apparatus according to claim 1 wherein the locator apparatus is incorporated into a piece of clothing.
